(19) United States
(12) Patent Application Publication
(10) Pub. No.: US 2007/0050228 A1
(43) Pub. Date: Mar. 1, 2007

(54) Schedule management

(75) Inventor: Aaron C. Beshears, Franklin, TN (US)

Correspondence Address: WELSH & KATZ, LTD, 120 S RIVERSIDE PLAZA, 22ND FLOOR, CHICAGO, IL, 60606, US

(73) Assignee: Aspect Communications Corporation

(21) Appl. No.: 11/212,080

(22) Filed: Aug. 24, 2005

(51) Int. Cl. G06F 9/46

(52) U.S. Cl. 705/9

(57) ABSTRACT

A method and system to assign a trial schedule of a plurality of trial schedules to a worker based on a worker ranking relative to other workers, and based on an order preference of the worker relating to a set of schedule abstractions, the set of schedule abstractions being respectively associated with the plurality of trial schedules.

### FIELD

The application relates generally to the field of customer interaction systems, more specifically the management of schedule systems, and to a machine-readable medium comprising instructions to perform this method.

### BACKGROUND

Workforce scheduling assigns personnel to respective work schedules periodically. Workforce scheduling may take into consideration forecasted customer demands, budgetary concerns (e.g., overtime), individual personnel skills and schedule preferences, and Federal Regulations (e.g., breaks). As the size of a workforce grows, so does the complexity of workforce scheduling.

Because of such complexity, workforce scheduling often does not have the flexibility to be responsive to changing forecast conditions to meet dynamic customer demands efficiently.

### SUMMARY

According to an aspect of the invention there is provided a method and system to assign a trial schedule of a plurality of trial schedules to a worker based on a worker ranking relative to other workers, and based on an order preference of the worker relating to a set of schedule abstractions, the set of schedule abstractions being respectively associated with the plurality of trial schedules.

### DESCRIPTION OF DRAWINGS

An example embodiment of the present invention is illustrated by way of example and not limitation in the figures of the accompanying drawings, in which like references indicate similar elements and in which:

FIG. 1 illustrates a schedule management system, according to an example embodiment of the present invention.

FIG. 2 illustrates various tables that may be maintained within one or more databases, according to example embodiments of the present invention.

FIG. 3 illustrates a shift bid diagram, according to an example embodiment of the present invention.

FIG. 4 illustrates a flow chart of a method, according to an example embodiment of the present invention.

FIG. 5 illustrates a sequence diagram between various system states, according to an example embodiment of the present invention.

FIGS. 6, 7A and 7B illustrate a set of graphical user interfaces to select a system status, according to an embodiment of the present invention.

FIGS. 8 and 9 illustrate a graphical user interface for system administration, according to an embodiment of the present invention.

FIGS. 10 to 26 illustrate a set of graphical user interfaces used to prepare at least one shift bid, according to an embodiment of the present invention.

FIGS. 27 to 30 illustrate a set of graphical user interfaces used to prioritize schedule classes during an open status, according to an embodiment of the present invention.

FIG. 31 shows a diagrammatic representation of machine in the example form of a computer system within which a set of instructions, for causing the machine to perform any one or more of the methodologies discussed herein, may be executed.

### DETAILED DESCRIPTION

According to an aspect of the invention there is provided a method and system to assign a trial schedule of a plurality of trial schedules to a worker based on a worker ranking relative to other workers, and based on an order preference of the worker relating to a set of schedule abstractions, the set of schedule abstractions being respectively associated with the plurality of trial schedules.

Architecture

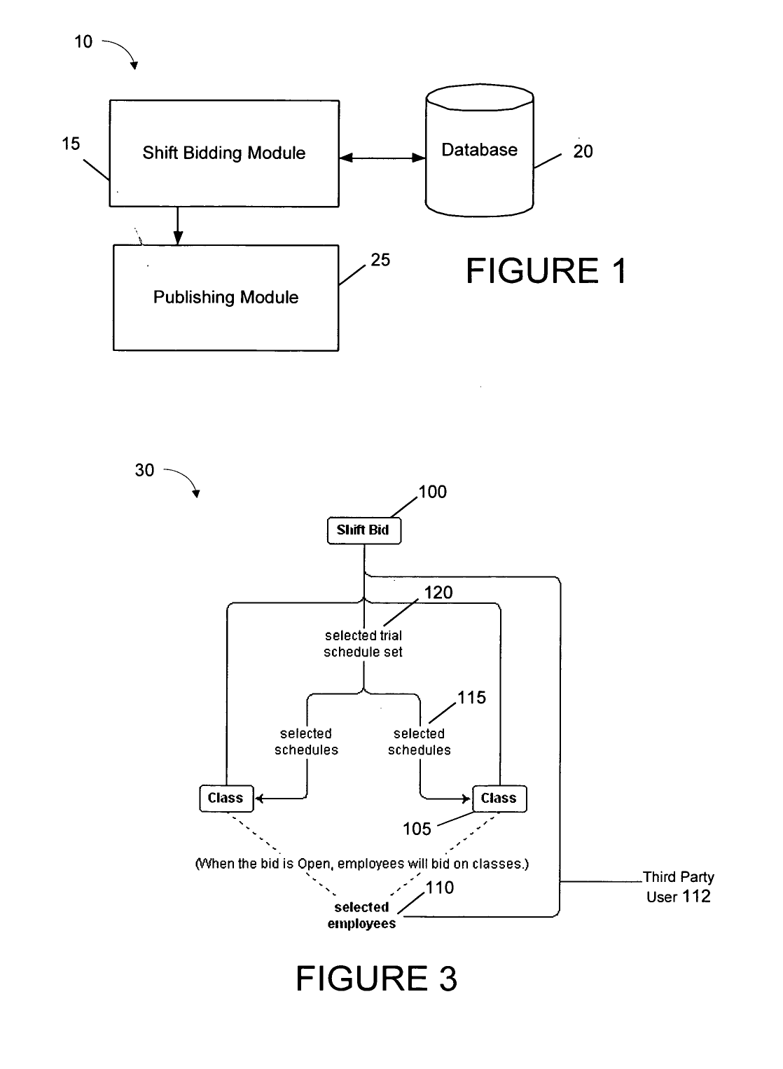

FIG. 1 illustrates a schedule management system 10, according to an example embodiment of the present invention. The schedule management system 10 includes an eWorkforce Management (eWFM) system 10, which includes a shift bidding module 15 to allow workers (such as employees) within the eWFM system to specify schedule preferences. Schedule preferences may be enumerated by placing abstract representations (such as classes) of schedules in order of preference, as described in more detail herein.

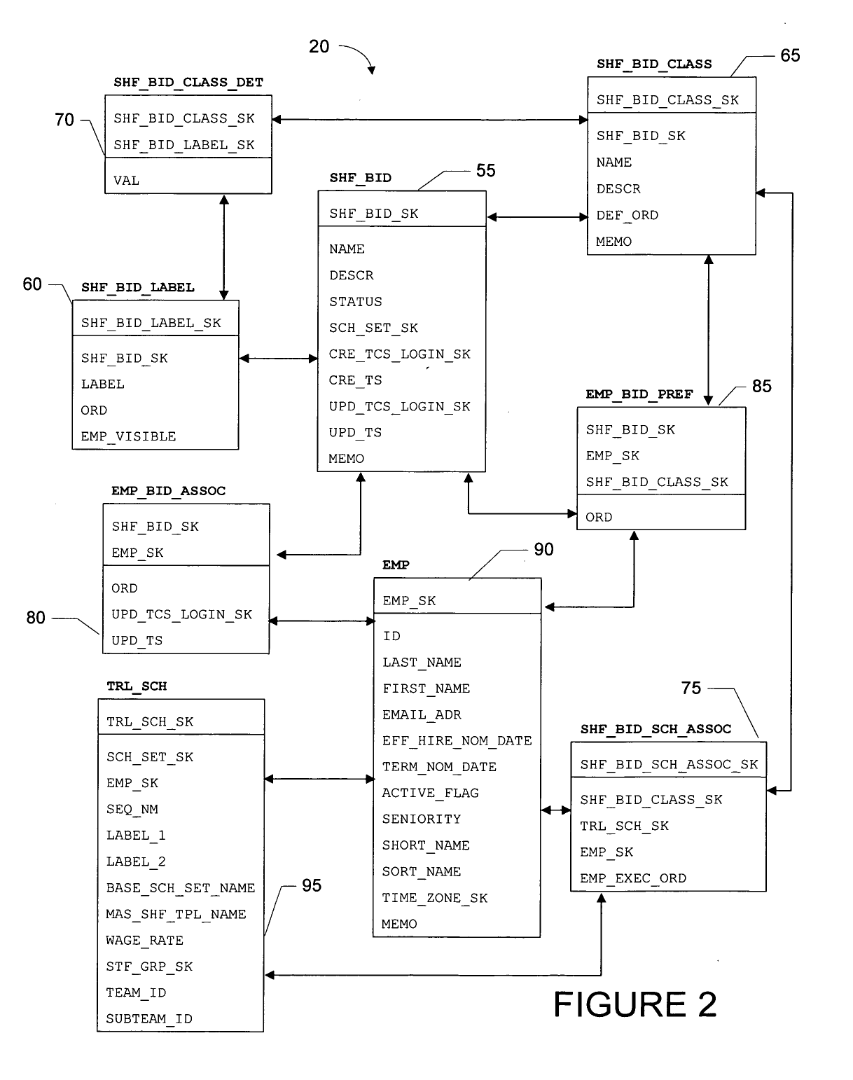

The shift bidding module 15 uses data from a database 25 to assign trial schedules to a worker. The data of the database 25 may include data associating each class (or schedule abstraction) to a trial schedule, data regarding worker ranking relative to other workers, and data regarding order preference of the worker associated with the set of classes, for example. Data tables are described in more detail with regard to FIG. 2.

An official schedule generated from the assigned trial schedule, as described in more detail herein, is published to at least one worker through the publishing module 20. Also, schedule changes may be published to the worker through the publishing module 20. In one embodiment, workers are notified of schedules and/or changes with an on-screen notification sent to worker desktops.

Data Model

FIG. 2 illustrates various tables that may be maintained within one or more databases 20, according to example embodiments of the present invention. These tables may support the shift bidding module 15.

A shift bid table 55 may hold a master record for a particular shift bid. Each data table may reference the shift bid table. The relationship may be delete cascade such that if a record in the shift bid table is deleted, then corresponding records in other tables may be automatically deleted.

A shift bid label table 60 may hold at least one label used to describe classes within the shift bid.

A shift bid class table 65 may hold the master records for the classes within the shift bid.

A shift bid class detail table 70 may hold at least one value assigned to each label for the classes in the shift bid.

A shift bid schedule association table 75 may hold a connection between at least one trial schedule and at least one class in the shift bid. Table 75 may also hold results of executing the shift, as described in more detail herein.

An employee bid association table 80 may hold a list of workers (such as employees) in the shift bid and the order they are considered for an assignment process. Table 80 may also hold a timestamp that is updated whenever the worker (such as an employee or a third party user) updates shift bid preferences.

An employee bid preference table 85 may hold shift bid preferences of a worker.

An employee table 90 may hold a list of workers that may participate in a shift bid.

A trial schedule table 95 may hold a list including at least one trial schedule. Several trial schedules may be associated with a single class. In this instance, a sequence number is assigned to each of these trial schedules to determine the order to fill them during the execution stage, as discussed in more detail herein.

Diagram

FIG. 3 illustrates a shift bid diagram 30, according to an example embodiment of the present invention. When defining a shift bid 100, a personal client (such as an administrative client) may define schedule classes 105. The schedule classes are schedule abstractions, such as a morning shift, an evening shift, a weekday shift, etc. After the shift bid is defined as described in more detail herein, the shift bid may be opened to workers 110 (such as employees or agents), to submit a preference order for these classes 105. After the shift bid is closed, the shift bid may be executed to assign workers 110 to selected trial schedules 115 from a trial schedule set 120. Each worker 110 may be assigned to the selected schedule 115 based on the trial schedule set 120, the relative ranking or priority order of the worker 110 in the bidding process, and the class preferences of the worker 110.

A shift bid third party user 112, such as an outside contractor who may help with overflow staffing, may also be assigned to the selected schedule 115 based on the trial schedule class assignments 120, the relative ranking or priority order of the worker 1 10 in the bidding process, and the class preferences of the worker 110. The third party user 112 may have a user interface that is consistent with the user interface style for other third party user applications.

In an alternative embodiment, the shift bid third party user 112 may also be a supervisor of the employee worker to bid for the employee worker, for example, when the employee worker may be unavailable or otherwise unable to prioritize the available schedule classes during the open stage as described herein.

Flow Chart

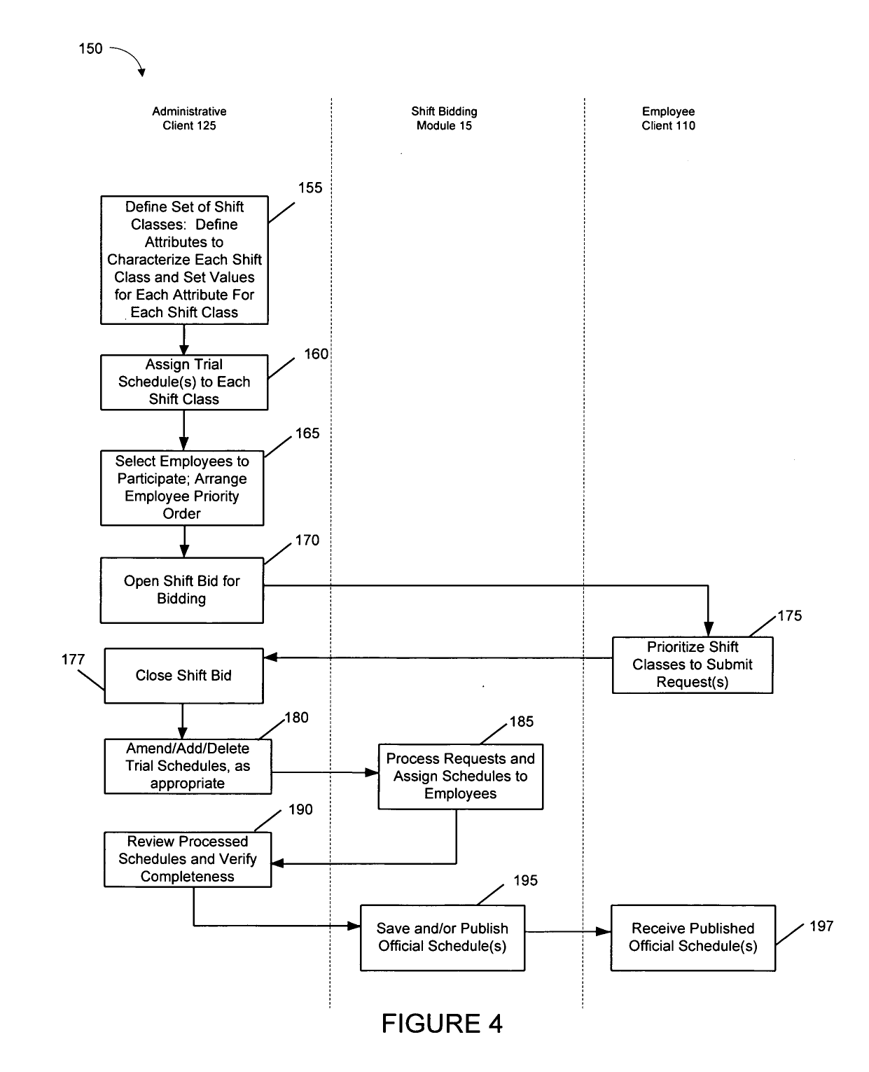

FIG. 4 illustrates a flow chart 150 of a method, according to an example embodiment of the present invention. The flow chart 150 includes side-by-side interaction and flow between administrative personal client 125, the shift bidding module 15, and the employee worker 110.

At block 155, a set of shift classes are defined as described herein, by the administrative personal client 125. The attributes (or labels) of each shift class are defined to characterize each shift class and to set values for each attribute for each shift class.

At block 160, trial schedules may be assigned to each shift class. The trial schedules may be assigned, added, deleted, or amended at any point before the trial schedules are assigned to employee workers at block 185, and in certain circumstances, as described herein, even after assigning schedules at block 185.

At block 165, employee workers that are to bid may be selected by the administrative personal client 125. The priority order of the employee workers may be arranged, as described herein.

At block 170, the administrative personal client 125 may open the shift bid for bidding.

At block 175, the shift classes may be prioritized by the employee worker 110 and saved and/or submitted as part of a request.

At block 177, the administrative personal client 125 may close the shift bid such that the employee worker 110 no longer has access to change the shift class priorities. In an instance where the employee worker did not have an opportunity to prioritize shift classes, a default priority may be assigned. In an additional embodiment, the supervisor of the employee worker (also known as the third party user) may select the shift class priorities for the employee worker.

At block 180, the trial schedules may be amended, added, or deleted, as appropriate. For example, revised forecasts of customer demands may show that more demand is needed on certain days around noon than around 11 am. The trial schedules may be adjusted to assure adequate and efficient coverage. If forecasting changes at any time, the administrative personal client 125 may alter the schedules dynamically as described herein.

At block 185, the shift bidding module 15 processes the requests from the employee workers to assign the trial schedules accordingly. The shift bidding module 15 may retrieve data concerning each employee worker in the shift bid, data concerning the employee worker priority order, data regarding each schedule class in the shift bid, and data regarding the trial schedules of each class and their respective sequence in the class.

In a particular embodiment, the shift bidding module 15 schedules each employee worker in order based on the priority order. The highest ranked employee worker may be assigned to the schedule class most preferred by the employee worker. Within the schedule class there may be more than two trial schedules in sequence. The trial schedule highest in sequence is filled first. The next highest employee workers in the ranking are then scheduled in a similar manner for available schedule classes and trial schedules.

At block 190, the administrative personal client 125 reviews the processed schedules and verifies that the schedules are completed. For example, the administrative personal client 125 ensures that each employee worker has a schedule, and that each shift is covered. If not, the administrative personal client 125 may return to any previous step or stage, as described herein.

At block 195, an official schedule is saved and/or published.

At block 197, the employee workers receive published official schedules. The employee workers may have the schedules published to their desktops as described herein.

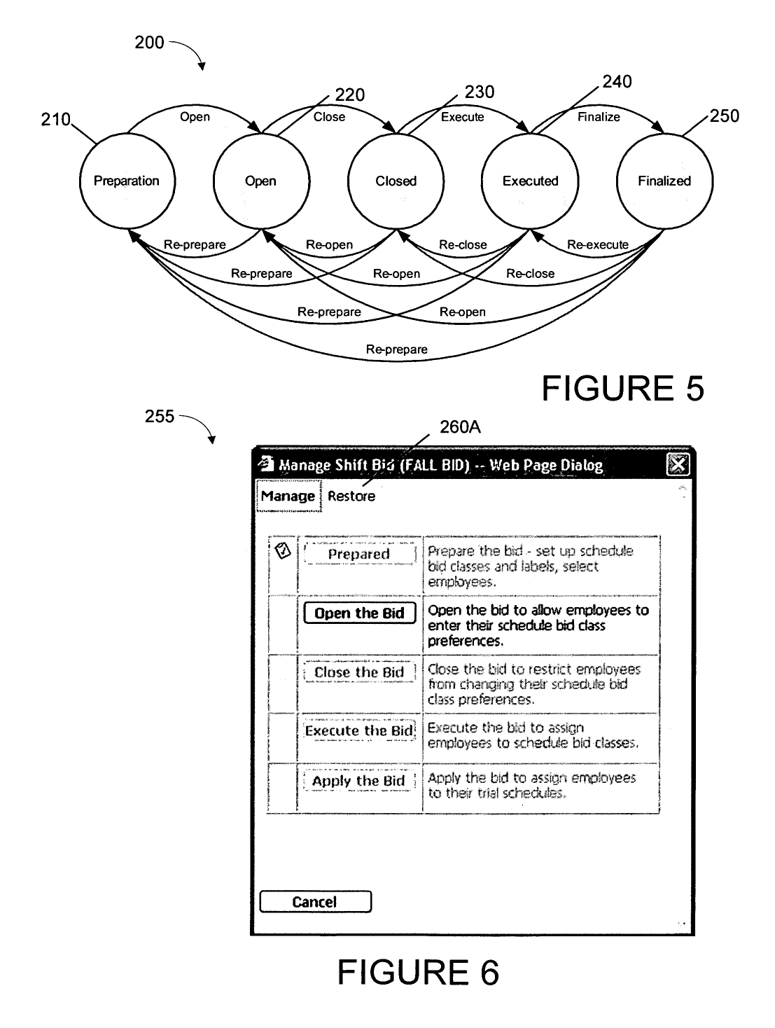

FIG. 5 illustrates a sequence diagram 200 between various system states, according to an example embodiment of the present invention. In order, the states include preparation of shift bid status 210, open bid status 220, closed bid status 230, execution of shift bid status 240, and finalization of shift bid status 250. As discussed in more detail herein, the administrative personal client 125 may transition between each of these statuses (or stages) to a forward stage and/or to a previous stage, as desired. For example, the administrative personal client 125 may not be satisfied after the execution stage and may want to re-execute.

The preparation state 210 is the state of a newly created shift bid and is the state while the bid is initially being configured. In the preparation state, data associating each of the set of schedule abstractions is received.

The open state 220 is the state where the shift bid is available for employee workers to define schedule class preferences. Order preference data is gathered during the open stage.

The closed state 230 is the state where employee workers can no longer define their shift bid preferences, unless the status is later changed back to open.

The executed state 240 is the state where trial schedule assignments have been made to employee workers within the shift bid by the shift bidding module 15. If the administrative personal client 125 selects “Execute,” then the shift bid is executed. This assigns employee workers to schedules based on employee worker class preferences. The assignments are saved to the database and the administrative personal client 125 may be presented with a user interface to show the results of the shift bid assignment.

The finalized state 250 is the state where the trial schedule assignments have been made. Employee workers may be assigned to trial schedules based on assignments in the shift bid class association table. If the administrative personal client 125 is satisfied with the execution results, the administrative personal client 125 may finalize the result, which will save the employee worker assignments to the trial schedules in the database(s).

After the finalized state or stage, the administrative personal client 125 may alter the trial schedules, and may re-execute to reassign schedules by transitioning to a previous stage. In an additional embodiment, after the finalized stage, the administrative personal client 125 may choose to publish official schedules.

User Interfaces

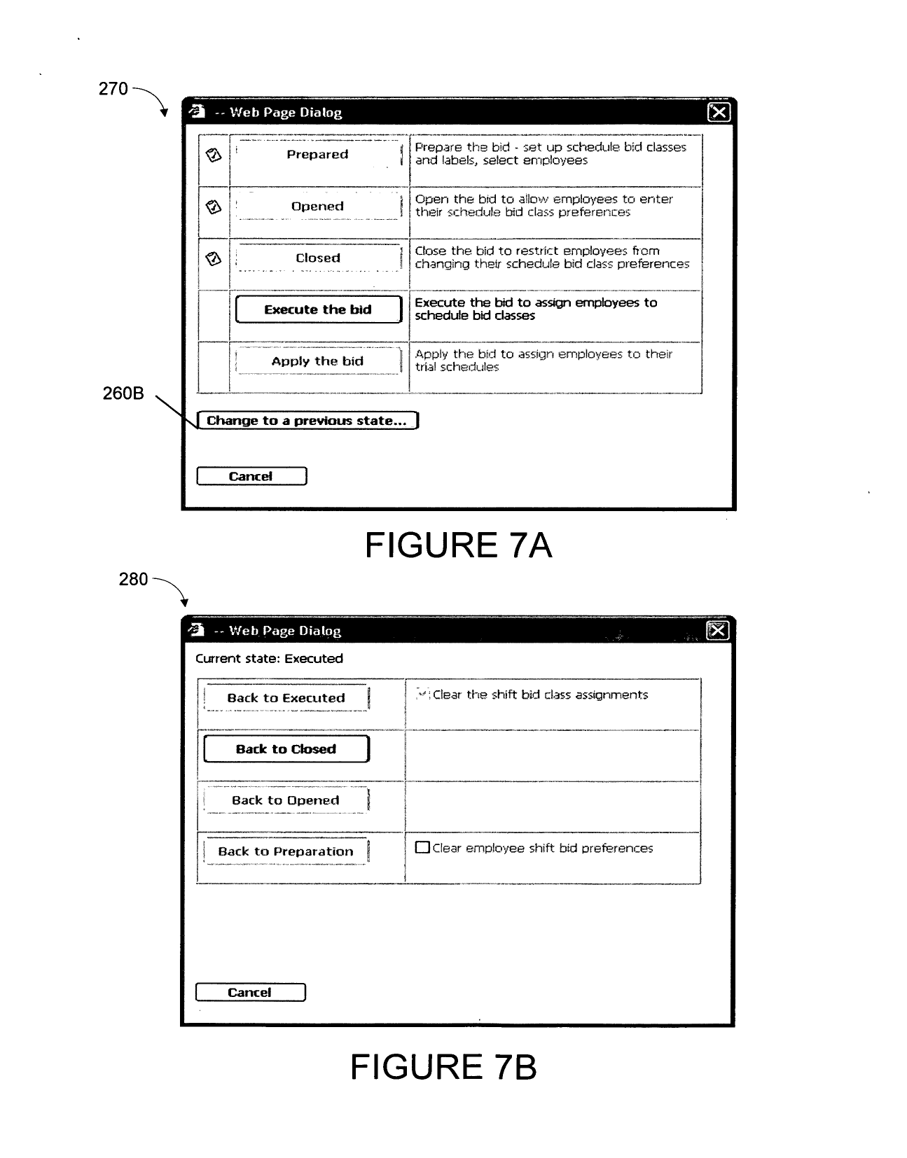

FIGS. 6, 7A and 7B illustrate a set of graphical user interfaces 255, 270, 280 to select a system status, according to an embodiment of the present invention. The user interface 255 of FIG. 6 includes two tabs. The first tab “Manage” indicates each of the possible states and indicates which state the shift bid may transition to next, e.g. Open the Bid. The second tab 260A “Restore” indicates a previous state or stage that the shift bid may transition back to. Upon selecting the tab 260A, the user interface may be similar to interface 280 of FIG. 7B.

The user interface 270 of FIG. 7A indicates that “Execute the Bid” is a next available transition state. A button 260B may be pressed to change to a previous state similar to the tab 260A.

The user interface 280 of FIG. 7B indicates which state the shift bid may transition back to after the tab 260A is used or the button 260B is depressed. When the state is changed to a previous state, the previous assignments and/or preferences may be cleared, edited, confirmed, or re-assigned.

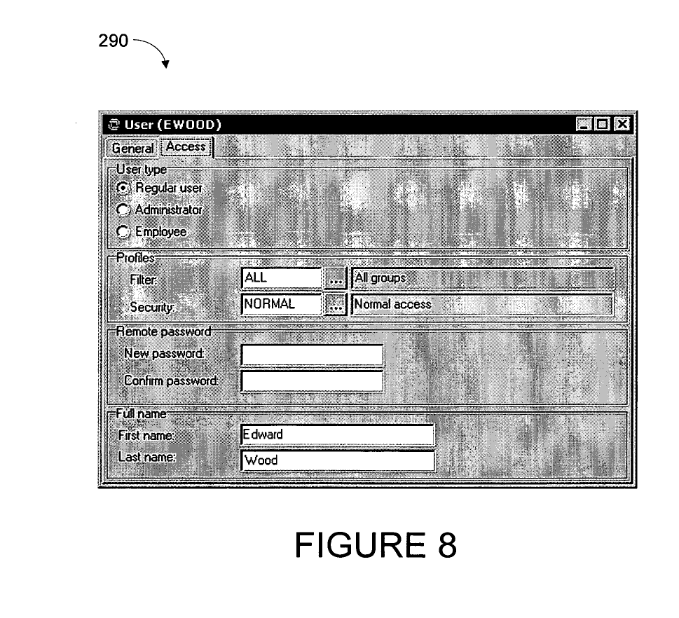

FIG. 8 illustrates a graphical user interface 290 for system administration, according to an embodiment of the present invention. FIG. 8 may be used by security administration to assign security and filter profiles to users, such as regular users, administrative personal clients, and employee workers. The security administration may have access to each of the five stages of the shift bidding module 15 (e.g., Normal Access) and may have access to each of the staff groups (e.g., All Groups). The regular user may have limited access to the shift bidding module 15 and/or to the staff groups. The administrative personal client 125 may have access to each of the five stages of the shift bidding module 15 and at least one staff group (filter) to create, edit and execute a shift bid for that at least one staff group. The shift bid employee worker (e.g., a first party user) may have access to the shift bidding module 15 during the open stage to bid as described herein. The shift bid third party user (e.g., a supervisor) may have access to the shift bidding module 15 during the open stage to bid for one or more shift bid employee workers.

The security administration may configure the shift bid administrative personal client 125 to define an application key for shift bid administration; to define application keys for staff groups; to associate application keys with security profile; and to assign security profiles to administrative personal clients who are to administer shift bidding for specific staff groups (to add, edit, delete shift bids for a set of staff groups).

The security administration may configure employee worker (and/or third party) access to shift bidding, and may define an application key for access to shift bidding. The security administration associates the application key with security profiles and assigns appropriate security and filter profiles to employee workers and third parties. The third parties may specify schedule class preferences on behalf of other users.

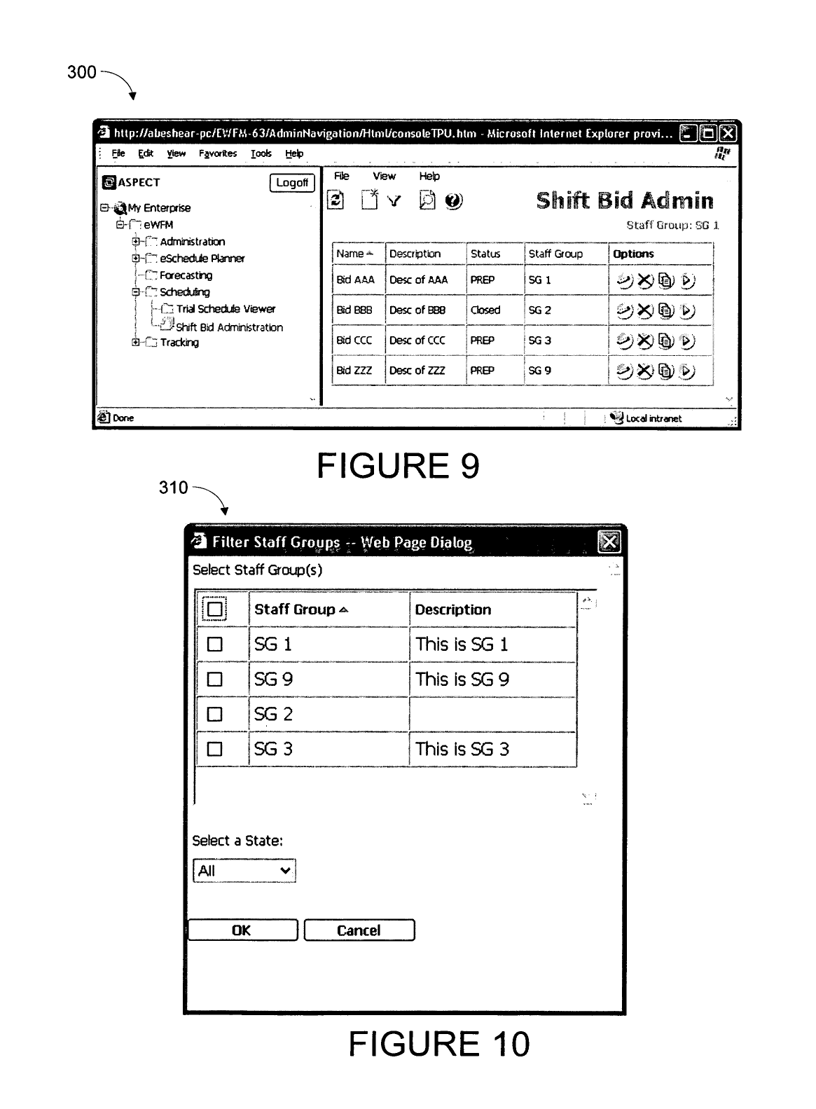

FIG. 9 illustrates a graphical user interface 300 for system administration, according to an embodiment of the present invention. When the administrative personal client launches the shift bid administration, the interface 300 may be presented. From this interface, the administrative personal client 125 may access the shift bidding module 15 to select the staff groups associated with the shift bids; view bids; create a new shift bid; edit an existing shift bid; create a copy (duplicate) an existing shift bid; delete a shift bid; change the status of a shift bid; execute a shift bid; and print preview shift bids.

From the list of shift bids, the administrative personal client 125 can update the status of a shift bid by clicking a button, such as a button having a forward-facing arrow. After the button is clicked, a user interface, similar to that of FIG. 6, may be presented by the administrative personal client 125.

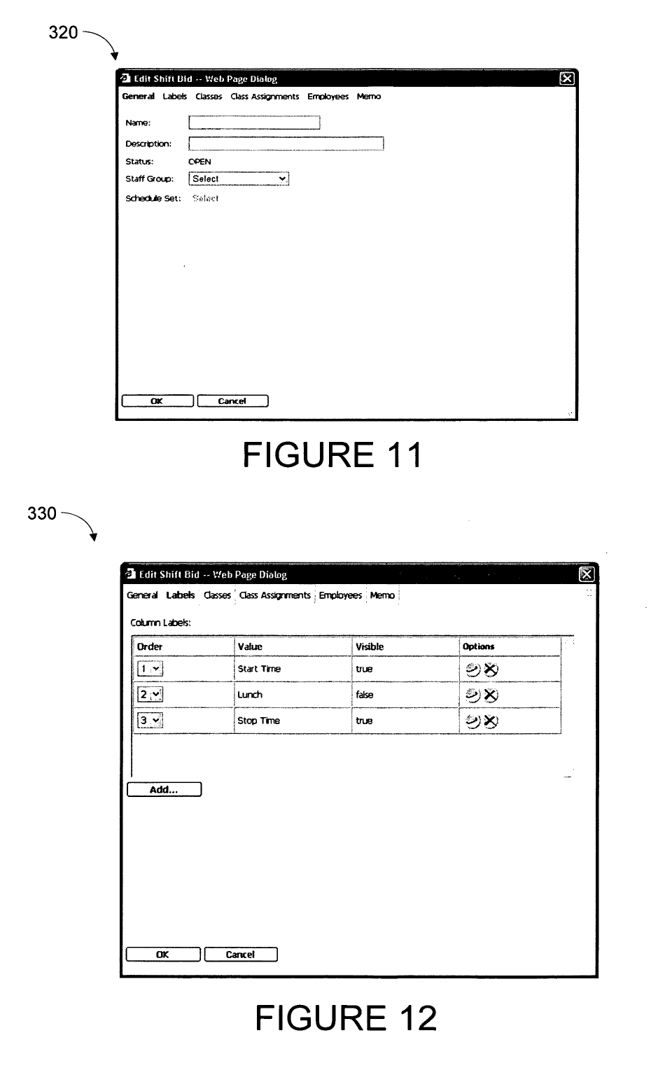

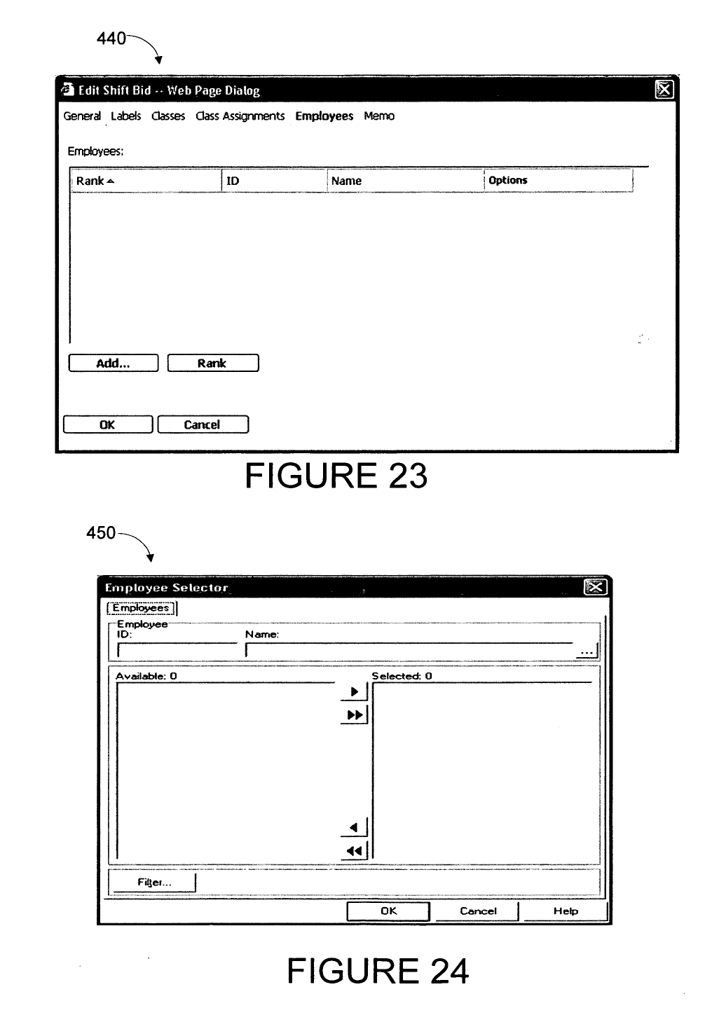

By selecting and/or clicking an add and/or edit button and/or feature on the user interface 300 of FIG. 9, the administrative personal client 125 is presented with user interfaces 320, 330, 350, 390, 420, 430, 440 of FIGS. 11, 12, 14, 18, 21 to 23 to add a class. FIG. 11 illustrates an interface 320 under a General Tab, FIG. 12 illustrates an interface 330 under a Labels Tab, FIG. 14 illustrates an interface 350 under a Classes Tab, FIG. 18, 21, 22 illustrate interfaces 390, 420, 430 under a Class Assignments Tab, and FIG. 23 illustrates an interface 440 under an Employees Tab.

FIG. 10 illustrates a graphical user interface 310 used to prepare at least one shift bid, according to an embodiment of the present invention. The administrative personal client 125 may filter or select staff groups associated with shift bids using the interface 310 at FIG. 10. The filtering may be defined by specifying a set of staff groups and a corresponding shift bid status. The list of staff groups that the administrative personal client 125 chooses from is limited to those which the administrative personal client 125 has access to, as defined by his security profile.

FIG. 11 illustrates a graphical user interface 320 used to prepare at least one shift bid, according to an embodiment of the present invention. When the administrative personal client 125 creates a new shift bid, edits a new shift bid, or duplicates a shift bid, a user interface similar to FIG. 11 may be presented. The first tab allows the administrative personal client 125 to specify general information about the shift bid. The administrative personal client 125 supplies a name and description. The list of staff groups is limited to those that an administrator has access to as defined by a security profile. When the administrator specifies a staff group for the shift bid, the schedule sets for that staff group are used in the schedule set drop-down. The administrative personal client 125 can then specify the schedule set for the shift bid. Changing the schedule set may clear trial schedule set assignments. A warning dialog may be included when the administrative personal client 125 changes the trial schedule set.

FIG. 12 illustrates a graphical user interface 330 used to prepare at least one shift bid, according to an embodiment of the present invention. Using interface 330, the administrative personal client 125 may specify at least one class value that may be used to define the classes for the shift bid. The class values (e.g., labels) may be deleted, edited or added, as desired by the administrative personal client 125. Buttons corresponding to these actions may be within the user interface 330.

The administrative personal client 125 also has the option of sorting the labels and defining an order the labels are presented in for the classes. The order for these labels defines the column order for the table of classes. The order may be changed by changing the drop-down. In the above illustration, changing the order for “Lunch” to 1 will change the order for “Start Time” to 2. Conversely, changing the order for “Lunch” to 3 will change the order for “Stop Time” to 2.

Each schedule abstraction (class) includes at least one label selected from a group including, but not limited to, type of work, start time range, number of working days, days off, days on, lunch time, break time, shift length, wage rate, and multiple work segments.

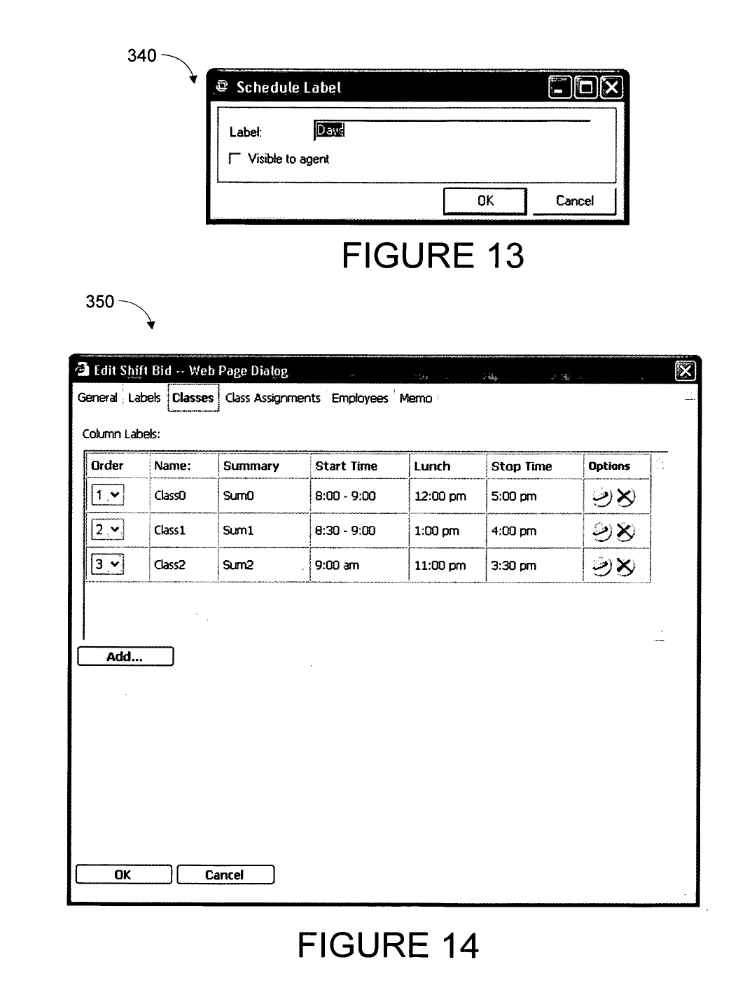

FIG. 13 illustrates a graphical user interface 340 used to prepare at least one shift bid, according to an embodiment of the present invention. When the administrative personal client 125 clicks the Add Button or clicks the Edit button, the user interface of FIG. 13 may be presented. A box or button within the user interface 340 may allow the administrative personal client 125 to decide whether or not to allow a particular label to be visible to an agent (e.g., the employee worker). If a new label is added, it is added to the end of the list of labels shown in FIG. 12.

FIG. 14 illustrates a graphical user interface 350 used to prepare at least one shift bid, according to an embodiment of the present invention. Under the “classes” tab, the administrative personal client 125 may be allowed to further define the classes for the shift bid. The columns generally correspond to the labels that were defined on the previous “Labels” tab. The administrative personal client 125 may be able to sort by these columns.

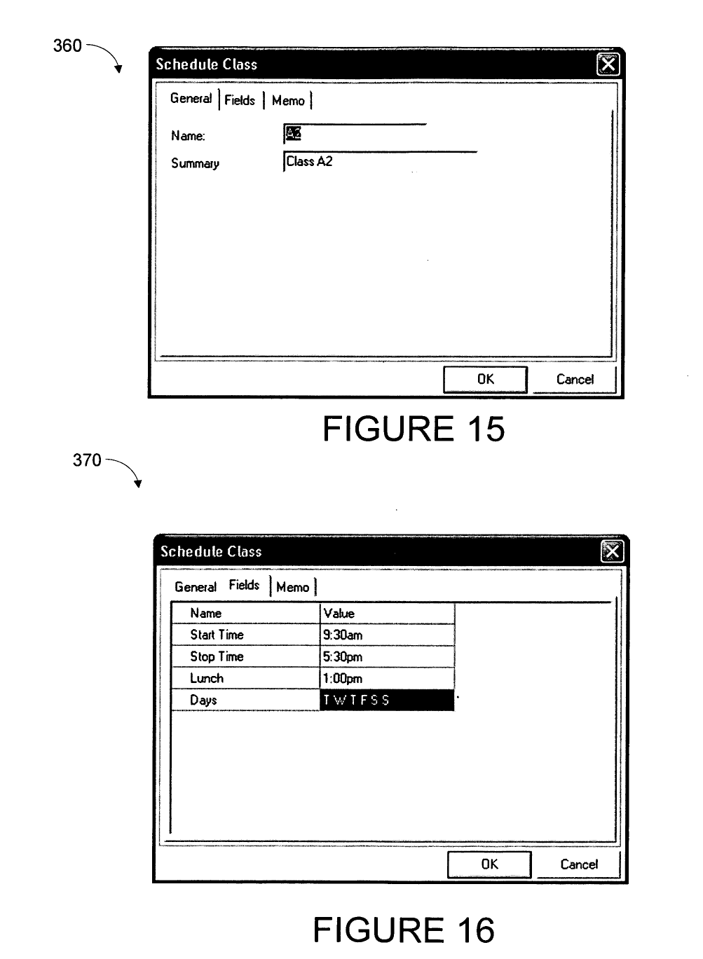

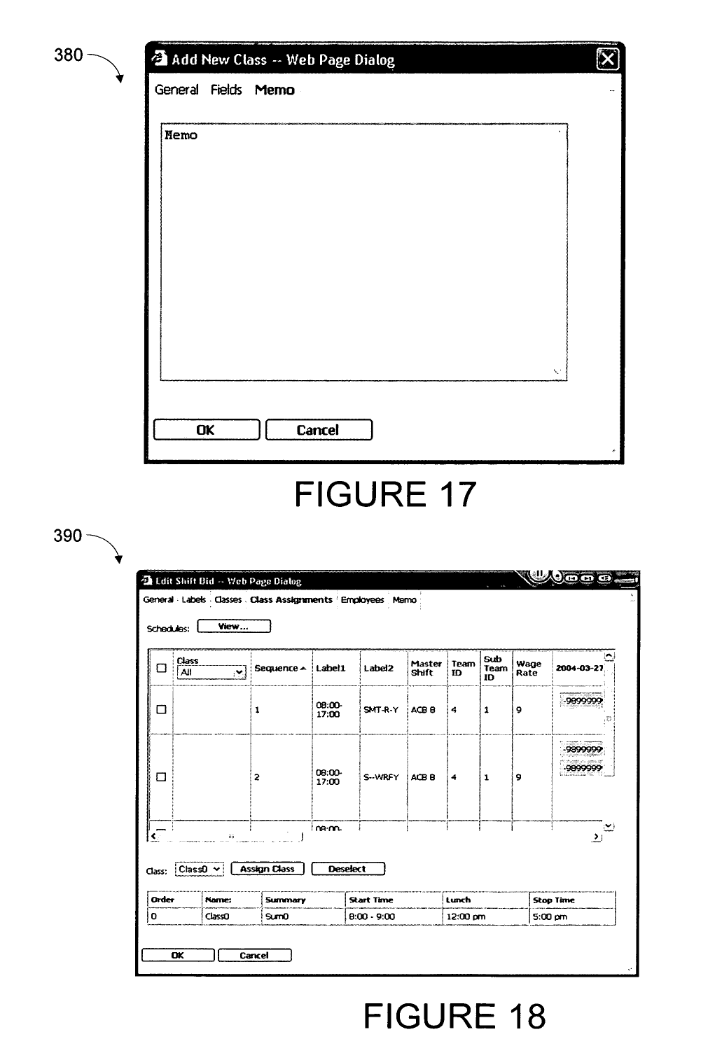

By selecting and/or clicking an Add button/feature on the user interface of FIG. 14, the administrative personal client 125 is presented with user interfaces 360, 370, 380 of FIG. 15, 16 or 17 to add a class. FIG. 15 illustrates an interface 360 under a General Tab, FIG. 16 illustrates an interface 370 under a Fields Tab, and FIG. 17 illustrates an interface 380 under a Memo Tab.

The graphical user interface 360 of FIG. 15 is used to add/edit a class name and a corresponding class summary, according to an embodiment of the present invention.

The graphical user interface 370 of FIG. 16 is used to define/add/edit values corresponding to previously-determined labels as part of the shift bid, according to an embodiment of the present invention. These values may each be considered to be strings.

The graphical user interface 380 of FIG. 17 is used to add a memo corresponding to the current class, according to an embodiment of the invention.

FIG. 18 illustrates a graphical user interface 390 used to prepare at least one shift bid, according to an embodiment of the present invention. After the schedule classes are defined, the administrative personal client 125 assigns the schedule classes to trial schedules. At the top half of the interface 390, a summary view of the trial schedules in a previously selected trial schedule set is shown. The trial schedules may be sorted by class, sequence, label or any other column. The appropriate schedule class may be selected with a drop-down menu at a bottom half of the interface 390.

The user interface allows the administrative personal client 125 to select a class and see the detailed information about the class; select the trial schedule detail information to display; see trial schedules and details about those trial schedules; sort trial schedules by different columns and filter by class assignments; and to select and deselect a class for a trial schedule.

To assign a class to a trial schedule, the administrative personal client 125 selects the class from the drop down menu. As each class is selected in the menu, appropriate trial schedules in the top half of the interface 390 are checked and/or selected to associate them with the selected class. The administrative personal client 125 then may assign by selecting an “Assign Class” button, for example. The summary table of the set of trial schedules is then updated to show the class assignment for the trial schedule(s).

To unassign a class for a trial schedule (so that the trial schedule is not associated with a class and thus is not part of the shift bid for that class), the administrative personal client 125 checks the trial schedule and presses a “Deselect” button on the interface, for example. The table is then updated to show that the trial schedule is not assigned to a class.

For a trial schedule to be considered by the shift bidding module 15 in the execution stage of the method described herein, the trial schedule is associated with a class that is part of the shift bid. If schedules are added to the trial schedule set, they will show up on this list as an unassigned trial schedule. However, at any time before the bid is opened at block 170 or during review and verification at block 190, the trial schedules may be assigned.

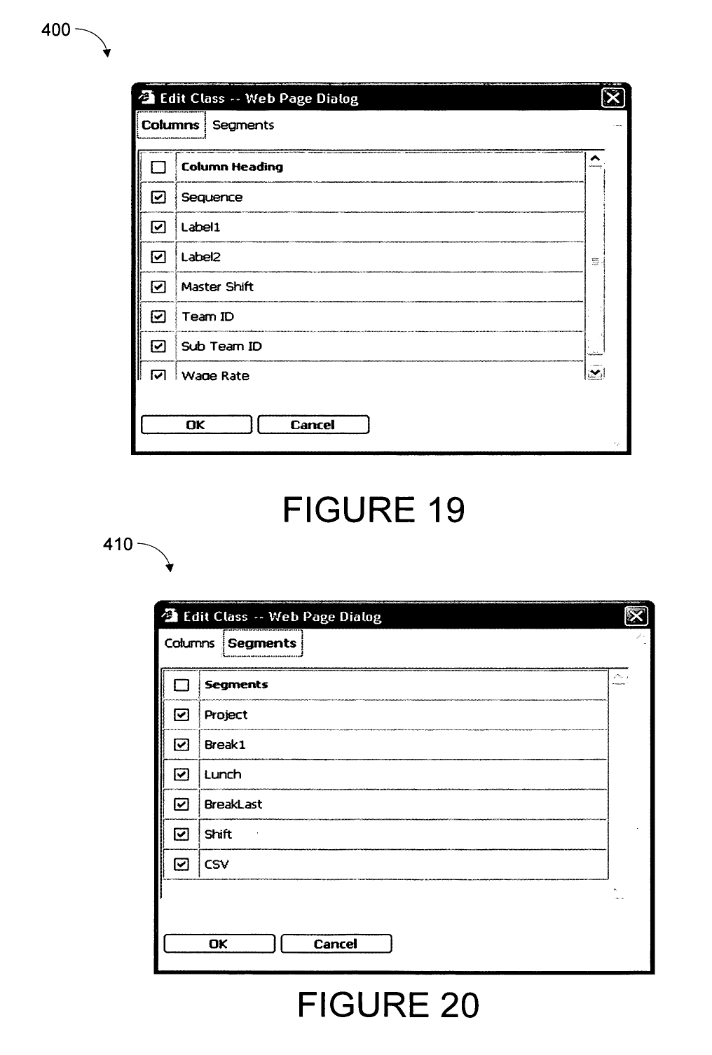

FIG. 19 illustrates a graphical user interface 400 according to an embodiment of the present invention. To define the columns that are shown for the trial schedules, the administrative personal client 125 selects or clicks a button to be presented with the interface 400. The standard columns for trial schedules may be displayed in addition to the set of nominal dates covered by the trial schedule. Thus if the trial schedule set was from 4/4-4/10, the list would be: Sequence, Label1, Label2, Master Shift, Team ID, Sub Team ID, Wage Rate, 4/4, 4/5, 4/6, 4/7, 4/8, 4/9, and 4/10.

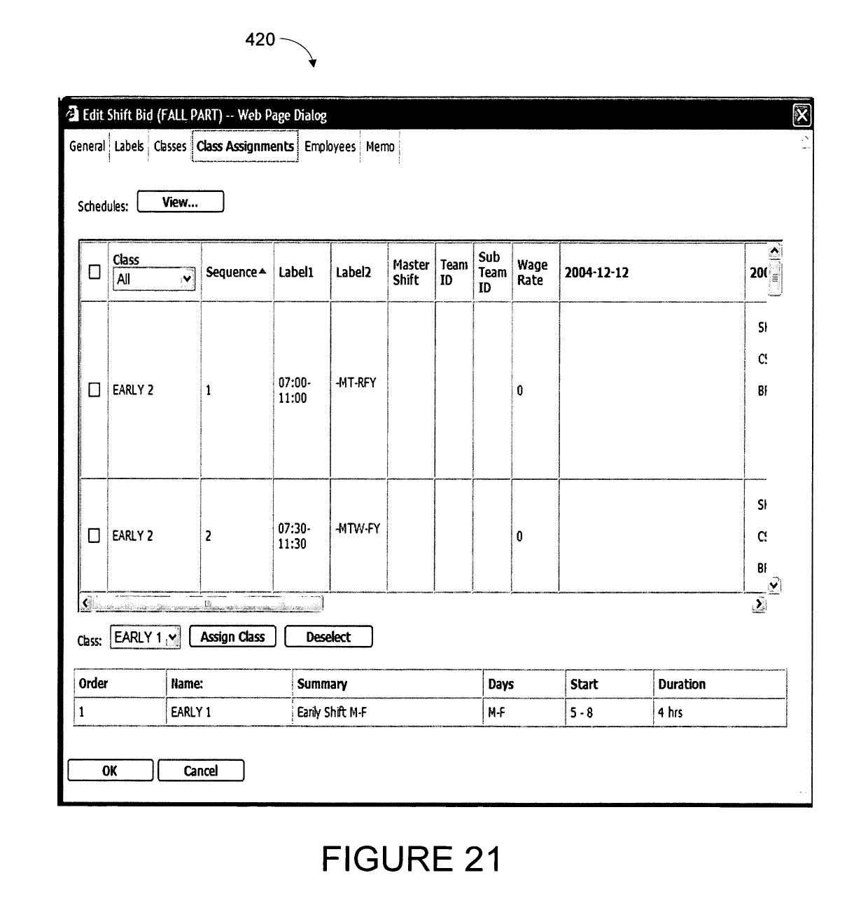

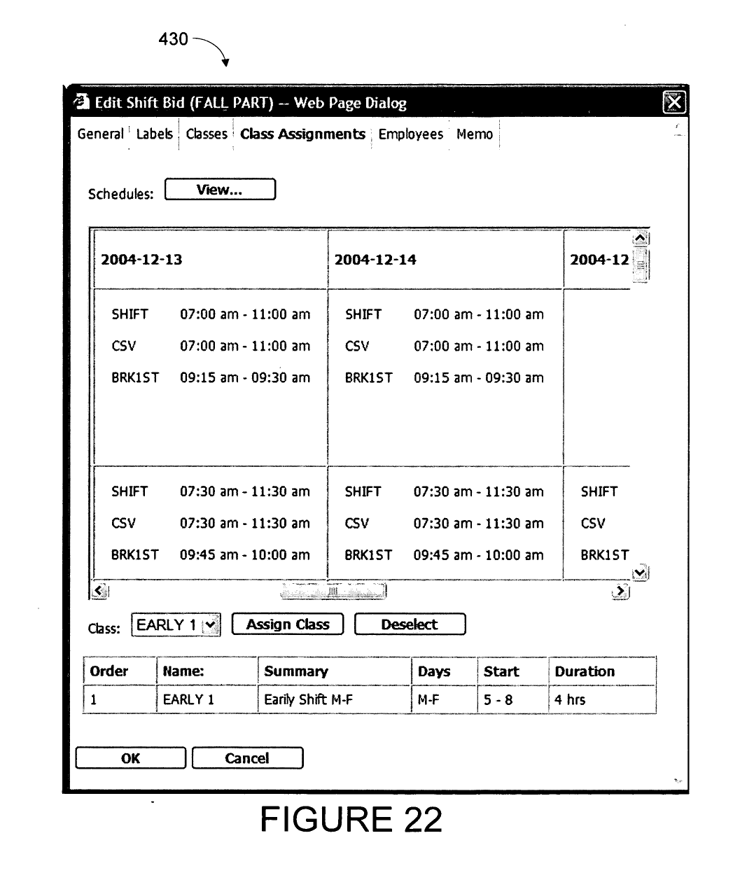

FIG. 20 illustrates a graphical user interface 410, according to an embodiment of the present invention. The administrative personal client 125 may further define the segments to see under each column date by selecting appropriate segments using the interface 410. FIGS. 21 and 22 illustrate interfaces 420, 430, which are alternatives to interface 390, and illustrate the segment selections of FIGS. 19 and 20 including shift time, the type of work associated with that shift (e.g., “CSV”, customer service), break times, and lunch times.

FIG. 23 illustrates a graphical user interface 440, according to an embodiment of the present invention. To define a shift bid, the administrative personal client 125 identifies the employee workers that are part of the bid. The list of employee workers is ordered or ranked, and this order defines the schedule assignment order processed at block 185. Employee workers may be added to this list by clicking an add button, for example to launch interface 450 of FIG. 24.

FIG. 24 illustrates a graphical user interface 450 illustrating an employee worker selector dialog, according to an embodiment of the present invention. Employee workers may be added in this interface. Employee workers may be added to the bottom of the employee worker list.

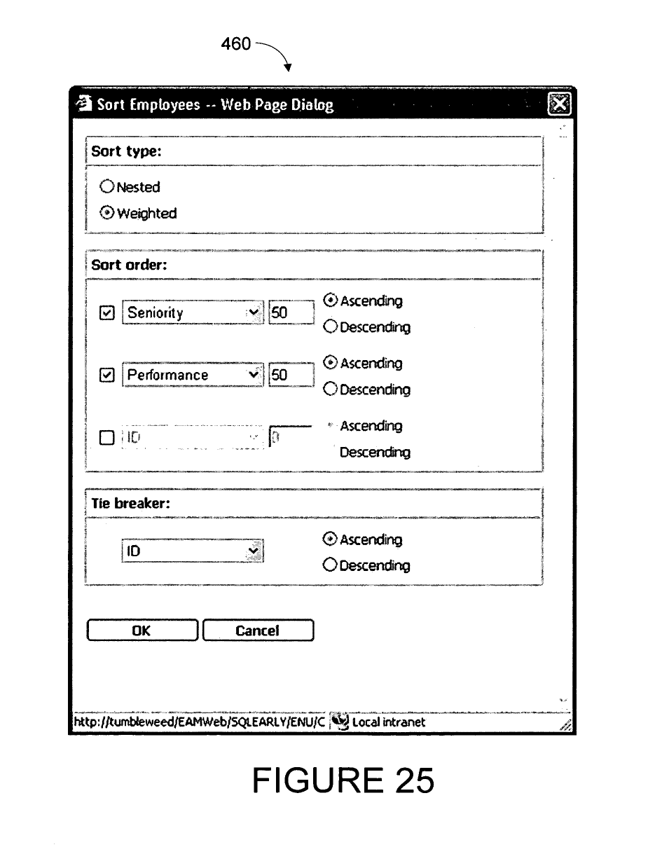

FIG. 25 illustrates a graphical user interface 460, according to an embodiment of the present invention. The employee workers may be reordered by clicking an appropriate button, such as sort, rank, or filter to launch a sort dialog. The sort dialog reassigns employee worker order by selected criteria For example, the sort order may be by seniority, performance, pay rate or any other criteria. The sort order may be ascending or descending. The sort type may be nested or weighted by selected percentages.

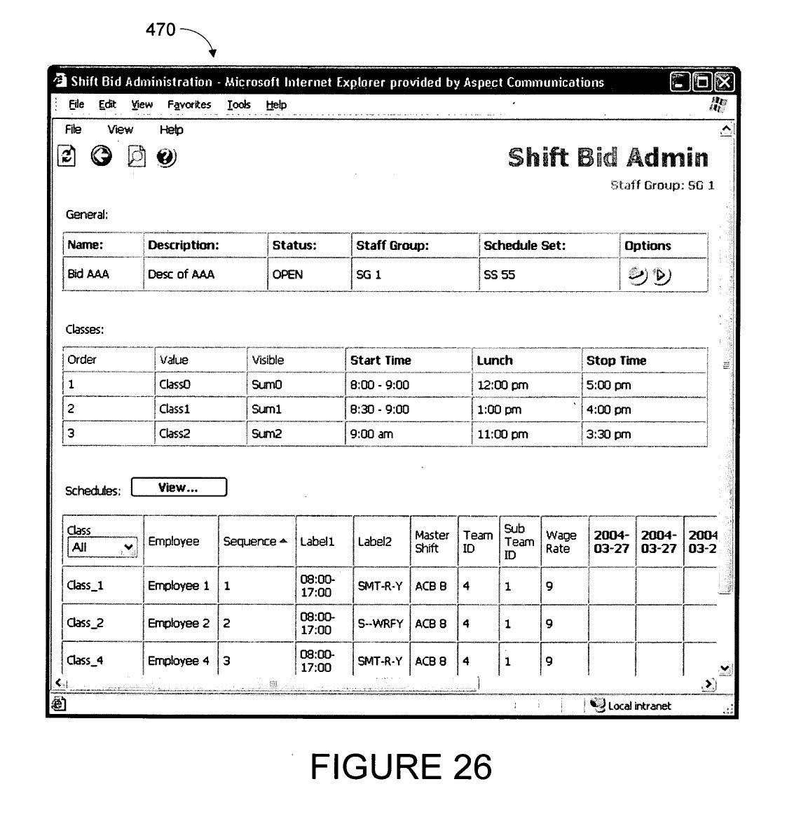

FIG. 26 illustrates a graphical user interface 470, according to an embodiment of the present invention. The interface 470 includes a shift bid, associated classes, and trial schedules associated with the classes. This interface 470 may be presented to the shift bid administrator (administrative personal client 125) before the bid is opened at block 170.

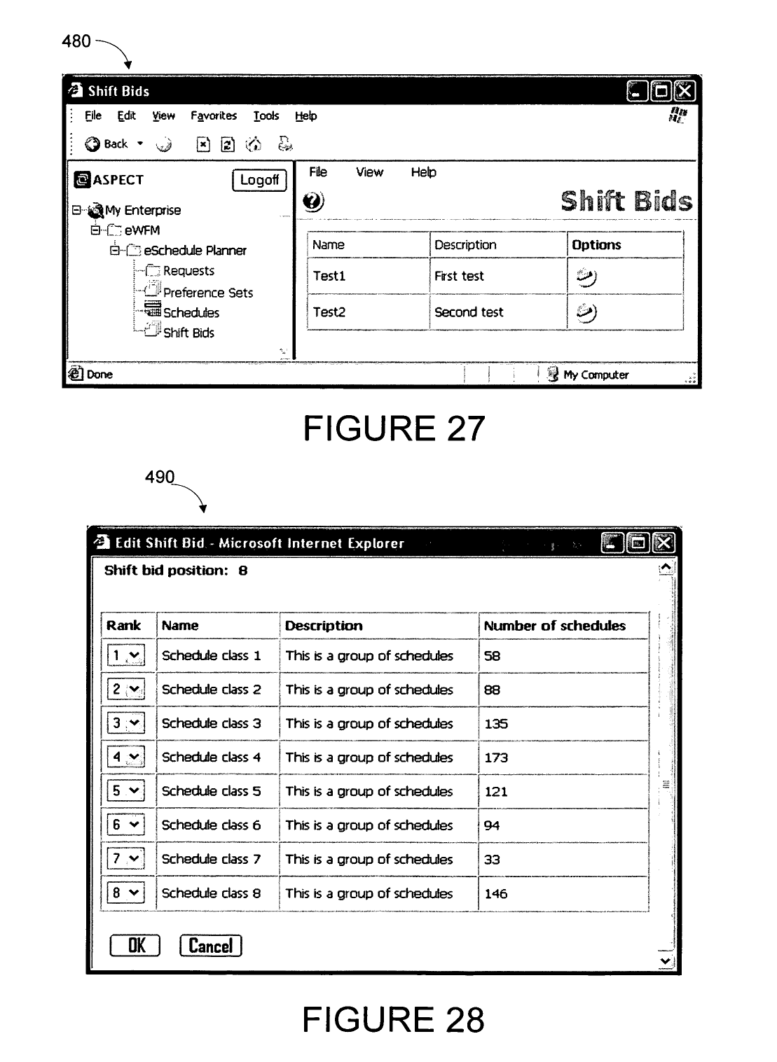

FIGS. 27 to 30 illustrate a set of graphical user interfaces 480 to 510 used to prioritize schedule classes during an open status, according to an embodiment of the present invention.

FIG. 27 illustrates an interface 480 that shows an employee worker (or a third party) each possible shift bid to which he/she has access. The employee worker may specify a shift bid preference by accessing the shift bidding module 15 within the eWFM/eSP. When the employee worker launches the shift bidding module 15, a list of open shift bids of which he/she is a member may be displayed as shown in FIG. 27. The employee worker (or third party) may view, select, and/or edit the appropriate shift bid by selecting an associated button, for example.

FIG. 28 illustrates an interface 490 that shows a shift bid edit display or shift bid order preference dialog. The shift bid edit display may include the shift bid position of the employee worker (or third party), and also may include a list of schedule classes on which to bid. The number of possible schedules associated with each class and a class description along with the employee worker (or third party) currently selected class rank may also be illustrated.

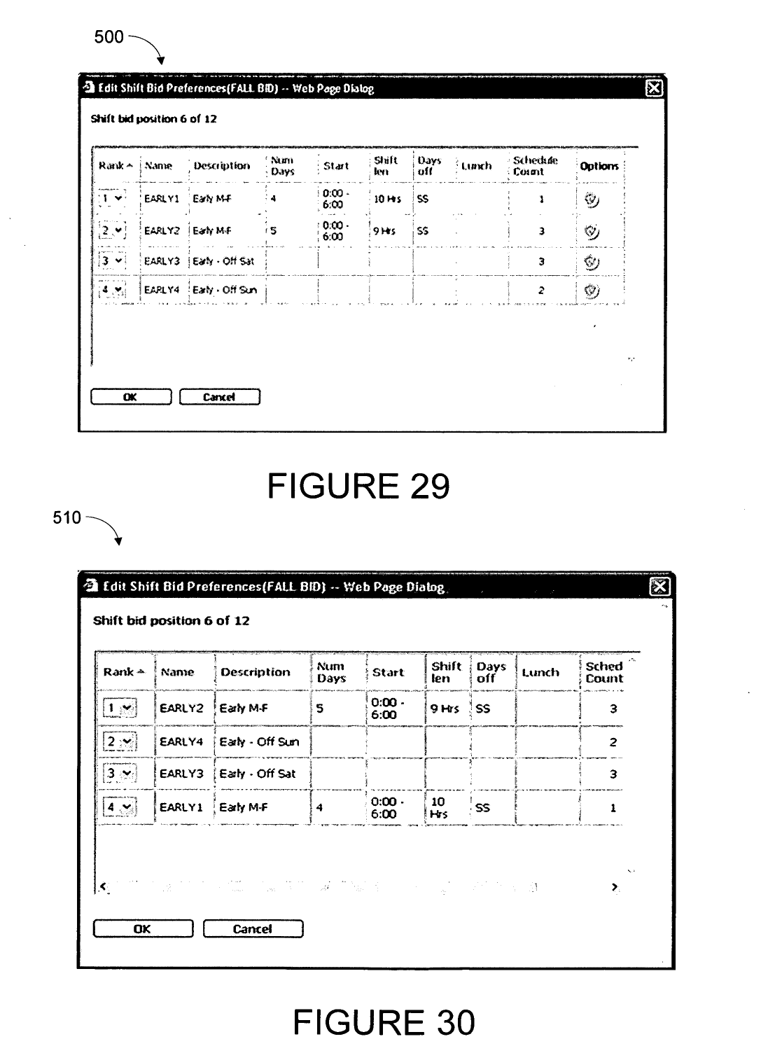

FIG. 29 illustrates an interface 500 before the employee worker has edited, modified, and/or selected order preferences associated with the classes.

FIG. 30 illustrates an interface 510 after the employee worker has edited the class ranking and selected shift bid preferences. The employee worker here has ordered classes EARLY2 as first, EARLY4 as second, EARLY3 as third, and EARLY1 as fourth. Each of the class schedule labels and/or values may also be shown in adjacent columns. Once the employee worker ranks the schedule preferences, the employee worker may submit the bid by clicking and OK button, for example.

The shift bid administrative personal client 125 may consume a minimal amount of time in scheduling employee workers and third party users with the methods and systems described. Also, the employee workers and third party users may consume a minimal amount of time in selecting and editing shift bid preferences with the methods and systems described. Further, before official schedules are finalized, the personal client 125 administrator may add, delete, or amend any trial schedules of the classes without having to re-open the bidding for the classes.

Computer Architecture

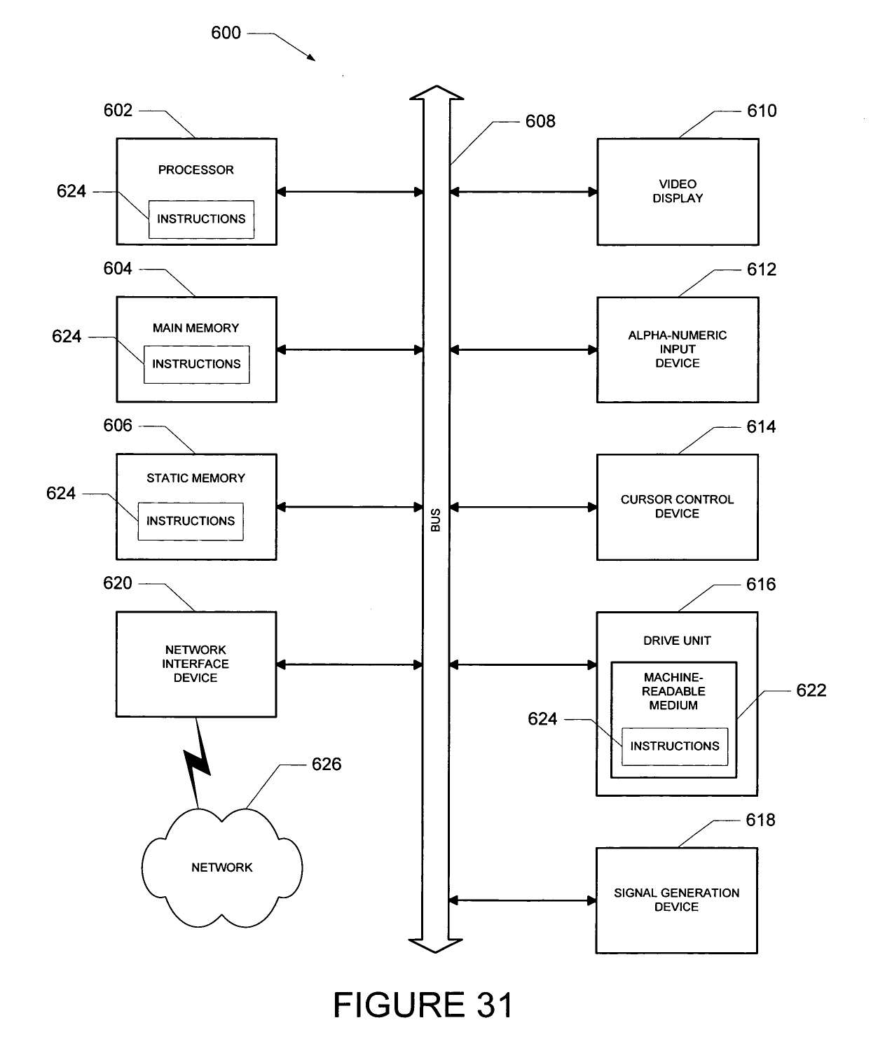

FIG. 31 shows a diagrammatic representation of machine in the example form of a computer system 600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, the main memory 604 and the processor 602 also constituting machine-readable media.

The software 624 may further be transmitted or received over a network 626 via the network interface device 620 utilizing any one of a number of well-known transfer protocols (e.g., HTTP).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Although an embodiment of the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

1. A method comprising:
assigning a trial schedule of a plurality of trial schedules to a worker based on a worker ranking relative to other workers, and based on an order preference of the worker relating to a set of schedule abstractions, the set of schedule abstractions being respectively associated with the plurality of trial schedules.

2. The method of claim 1 wherein each schedule abstraction of the set of schedule abstractions includes at least one attribute selected from a group including type of work, start time range, number of working days, days off, days on, lunch time, break time, shift length, wage rate, and multiple work segments.

3. The method of claim 1 wherein the plurality of trial schedules are associated with a first schedule abstraction of the set of schedule abstractions, and further including assigning the trial schedule of the plurality of trial schedules to the worker of a plurality of workers based on a sequence of the trial schedule within the first schedule abstraction.

4. The method of claim 1 further comprising receiving data defining the set of schedule abstractions.

5. The method of claim 1 further comprising publishing an official schedule associated with the assigned trial schedule.

6. The method of claim 1 further comprising receiving data defining each trial schedule.

7. The method of claim 1 further comprising transitioning between a plurality of stages, wherein the plurality of stages includes a preparation stage to receive the data associating each of the set of schedule abstractions, an open stage to gather order preference data from the worker, a closed stage to close the open stage, an execution stage to assign one of the trial schedules to the worker, and a finalized stage where the trial schedule assignments are finalized.

8. A machine-readable medium storing a sequence of instructions that, when executed by a computer, cause the computer to perform the method of claim 1.

9. A system comprising:
means for receiving data associating each of a set of schedule abstractions to a respective trial schedule of a plurality of trial schedules; and
means for assigning a trial schedule of the plurality of trial schedules to a worker based on a worker ranking relative to other workers, and based on an order preference of the worker relating to the set of schedule abstractions.

10. The system of claim 9 wherein each schedule abstraction of the set of schedule abstractions includes at least one attribute selected from a group including type of work, start time range, number of working days, days off, days on, lunch time, break time, shift length, wage rate, and multiple work segments.

11. The system of claim 9 wherein the plurality of trial schedules are associated with a first schedule abstraction of the set of schedule abstractions, and further including means for assigning the trial schedule of the plurality of trial schedules to the worker of a plurality of workers based on a sequence of the trial schedule within the first schedule abstraction.

12. The system of claim 9 further comprising means for receiving data defining the set of schedule abstractions.

13. The system of claim 9 further comprising means for publishing an official schedule associated with the assigned trial schedule of the plurality of trial schedules.

14. The system of claim 9 further comprising means for receiving data defining each trial schedule of the plurality of trial schedules.

15. A system comprising:
a shift bidding module to assign a trial schedule of a plurality of trial schedules to a worker based on a worker ranking relative to other workers, and based on an order preference of the worker relating to a set of schedule abstractions, the set of schedule abstractions being respectively associated with the plurality of trial schedules.

16. The system of claim 15 further comprising a publishing module to publish an official schedule associated with the assigned trial schedule of the plurality of trial schedules.

17. The system of claim 15 further comprising a schedule abstraction database to store the set of schedule abstractions, wherein each schedule abstraction includes at least one attribute selected from a group including type of work, start time range, number of working days, days off, days on, lunch time, break time, shift length, wage rate, and multiple work segments.

18. The system of claim 15 further comprising a database to define each trial schedule of the plurality of trial schedules.

19. The system of claim 15 wherein the plurality of trial schedules are associated with a first schedule abstraction of the set of schedule abstractions, the system further comprising a database including a sequence of the plurality of trial schedules within the first schedule abstraction, wherein the shift bidding module further is to assign the trial schedule of the plurality of trial schedules to the worker of a plurality of workers based on the sequence of the trial schedule within the first schedule abstraction.

20. The system of claim 15 further comprising a database to define the worker ranking.

21. The system of claim 15 further comprising a database to define the order preference.
